(19) United States
(12) Patent Application Publication
(10) Pub. No.: US 2014/0160153 A1
(43) Pub. Date: Jun. 12, 2014

(54) METHOD AND SYSTEM FOR REAL-TIME LEARNING AND COLLABORATION SOLUTION

(71) Applicant: Jatinder Pal Singh, San Ramon, CA (US)

(72) Inventor: Jatinder Pal Singh, San Ramon, CA (US)

(21) Appl. No.: 13/708,877

(22) Filed: Dec. 7, 2012

(51) Int. Cl. G09G 5/00; G09G 5/377

(52) U.S. Cl. CPC G09G 5/00; G09G 5/377
USPC 345/629; 345/1.1

(57) ABSTRACT

In one exemplary embodiment, a method for a real-time learning and collaboration environment comprising a first user's computing device and a second user's computing device to access a first digital whiteboard generated by the first user's computing device. A first modification is received from a first user to the first digital whiteboard. The first digital whiteboard is modified according to the first modification. A second user's computing device is enabled to generate a second digital whiteboard. The second digital whiteboard can overlay a view of the first digital whiteboard. A second modification is received from a second user to the second digital whiteboard. The view of the second digital whiteboard overlaying the first digital whiteboard is modified according to the second modification. A master view of the first view of the first digital whiteboard and the second view of the second digital whiteboard is provided to a whiteboard management dashboard application in the first user's computing device.

### CROSS-REFERENCE TO RELATED APPLICATIONS

This application claims priority U.S. Provisional Application No. 61/568,761, titled System and Method of Real-time Learning and Collaboration Solution and filed Dec. 9, 2011 and U.S. Provisional Application No. 61734911, titled System and Method of Real-time Learning and Collaboration Solution and filed Dec. 7, 2012. The provisional applications are hereby incorporated by reference in its entirety.

### BACKGROUND

1. Field

This application relates generally to information sharing systems, and more specifically to a system and method of a real-time learning and collaboration solution system with digital whiteboards.

2. Related Art

Students working in a classroom environment, doing homework or preparing for a test may encounter a need for assistance when faced with a problem. They may also wish to take their own notes and reference those notes while doing their homework or assignments. Access to guidance at the “teaching moment” may be critical to problem solving and for a student's success. Teachers, who are often faced with large class sizes, may not always have the tools to provide individualized help or in-class collaborations in a normal class setting.

For example, after teaching a concept a teacher may like to assign problems to the students and monitor individual work without walking to each student's desk. Alternatively, a teacher may like to create multiple groups, allow them to collaborate on solving assigned problems, and monitor each group's work and share with the rest of the class. Teachers may also need information on the amount of time that each student may be spending on doing tests, quizzes and homework helping them to focus on providing specific help where a student may need or on types of problems where most students may be struggling. Teachers may also end up spending an inordinate amount of time in photocopying, homework corrections and distributing classroom materials, at the expense of instructional time. Students may be further constrained by not having access to qualified after-school tutoring resources or study groups that can supplement their classroom learning.

### BRIEF SUMMARY OF THE INVENTION

In one exemplary embodiment, a method of a real-time learning and collaboration environment comprising a first user's computing device and a second user's computing device to access a first digital whiteboard generated by the first user's computing device. A first modification is received from a first user to the first digital whiteboard. The first digital whiteboard is modified according to the first modification. A second user's computing device is enabled to generate a second digital whiteboard. The second digital whiteboard overlays a view of the first digital whiteboard. A second modification is received from a second user to the second digital whiteboard. The view of the second digital whiteboard overlaying the first digital whiteboard is modified according to the second modification. A master view of a first view of the first digital whiteboard and a second view of the second digital whiteboard is provided to a whiteboard management dashboard application in the first user's computing device.

### BRIEF DESCRIPTION OF THE DRAWINGS

The present application can be best understood by reference to the following description taken in conjunction with the accompanying figures, in which like parts may be referred to by like numerals.

FIG. 1 illustrates the deployment of various components of a real-time learning and collaboration solution system, according to some embodiments.

FIG. 2 shows a teacher in a classroom with four students, according to some embodiments.

FIG. 3 shows three students and a teacher, all in remote location in a meeting, according to some embodiments.

FIG. 4 simulates meeting among three collaborating participants of a dispersed workforce.

FIG. 5 depicts, in block diagram format, a teacher connected with four students in a classroom or in remote locations, according to some embodiments.

FIG. 6 shows the initiator of a meeting connected with four collaborating participants of a dispersed workforce in remote locations, according to some embodiments.

FIG. 7 illustrates a sample computing environment that can be utilized in some embodiments.

FIG. 8 depicts an exemplary computing system that can be configured to perform any one of the above-described processes.

FIG. 9 shows a teacher engaged in a collaboration meeting with three students in remote locations, and a system of communication workflows, according to some embodiments.

FIG. 10 illustrates a dashboard view of six students available to the teacher on his/her writable tablet, according to some embodiments.

FIGS. 11A-B depict an example process for a real-time learning and collaboration solution system, according to some embodiments.

FIG. 12 depicts another process that can be utilized to implement various examples described herein, according to some embodiments.

### DETAILED DESCRIPTION

Disclosed are a system, method, and article of a real-time learning and collaboration solution system. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown.

Reference throughout this specification to “one embodiment,” “an embodiment,” “some embodiments”, or similar language means that a particular feature, structure, or characteristic described in connection with the embodiment is included in at least one embodiment of the present invention. Thus, appearances of the phrases “in one embodiment,” “in an embodiment,” “in some embodiments”, and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

In one embodiment, a cloud-based, platform-neutral application can run on various computing devices such as personal computers, laptop computers, tablet computers, smart phones, and the like. Additionally, the application can be deployed in both classroom and home environments. The system can include, inter alia: a function-rich whiteboard application, simulating real-time, face-to-face interactions, a tablet and mobile device centric user-interface designs; a built-in text, audio and video features, allowing multiple modes of communication; a course management and project collaboration application; integration with social media applications.

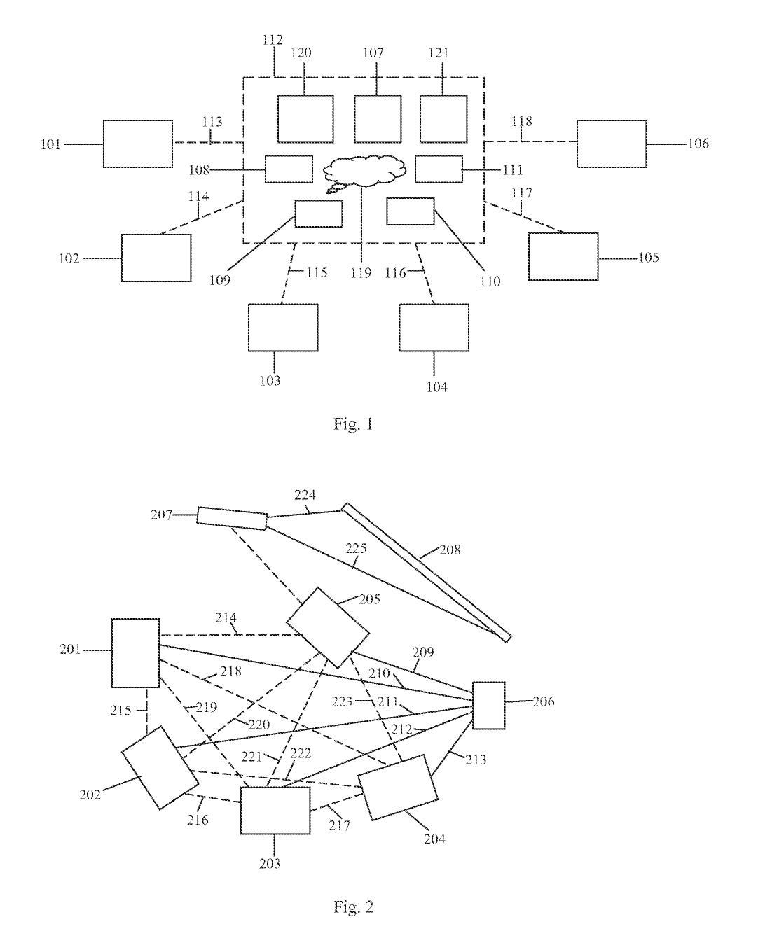

FIG. 1 illustrates the deployment of the following components of a real-time learning and collaboration solution system: proprietary whiteboard application 107, document management system 108, voice-over-IP software 109, audio-video application 110, social networks 111, knowledge-exchange platform 120 and content providers 121, according to some embodiments.

A wide variety of devices such as desktop personal computer (PC) 101, laptop computer 102, smart phone 103, writable tablet 104, motion-enabled gaming console 105 and/or an instructor-led writable tablet and LCD projector system 106 can be networked 113, 114, 115, 116, 117, 118 to collaborate and sharing of information using VPN (virtual private network) or the internet 119. The knowledge exchange platform 120 allows for storing, retrieving, sharing, exchanging, and commercially transacting customized content.

The in-built middle-tier application 112 can controls various components, interaction among devices, multiple modes of communication, and exchange of data. Content providers 121 can make their content available for commercial transactions using knowledge exchange platform 120. Users can create their own content or customize content by annotating on top of the content that is made available by the content providers 121. Further or multiple modification and customization of content that is already available on the knowledge exchange platform 120, can be stored, shared, exchanged or commercially transacted.

In addition, some embodiments can make provision for: phone dialing into an ongoing session; subscriptions to existing channels on a video-sharing website (e.g. YouTube®, Khan Academy®), to avail the benefit of thousands of videos on academics and training topics of choice; enabling the users to pull their existing online friends from an online social networking service (e,g. Facebook®, Twitter®, and the like) into a virtual meeting for a full audio/video session with multiple whiteboard windows (a whiteboard window can be referred to as a ‘whiteboard’ and/or a ‘whiteboard layer’) in operation to allow writing in free-hand expression, provide instructions, and sharing of screens; enabling users to annotate on multiple whiteboards, substantially simultaneously in real-time. While one user is writing on a whiteboard layer, the second user can write or annotate substantially simultaneously on a second whiteboard layer that is superimposed on the first whiteboard. Similarly there can be a third user writing substantially simultaneously in real-time on a third whiteboard layer while first two users are writing on their individual layers, and all three whiteboards are superimposed and synchronized.

It is noted, that the user definition can change depending on the context. A user can be a student, teacher, tutor, administrator, dispersed workforce, researcher, doctor, attorney or legal counsel, individual interacting with his/her friends. In short, virtually anyone engaged in a learning and collaboration process can be defined as a user.

The whiteboard application can be a component of some embodiments. Below is a description of the whiteboard architecture, and how its various elements can function when deployed in a typical, real-time learning and collaboration environment.

In some embodiments, a real world whiteboard can be emulated on which anything can be drawn in free hand. Alternately, words can also be typed onto the digital whiteboard (e.g. a virtual whiteboard displayed with a computing device display) using a keyboard. An image, screenshot of a web page or a file or document in any format such as Word®, Excel® Spreadsheet, Power Point or PDF can also be rendered on the whiteboard window on a computer screen.

The whiteboard application can be configured to convert any document, file or image into a proprietary format before they are rendered on the whiteboard. Further, annotations on a blank whiteboard page or a document, file or image that have been rendered on the whiteboard page can get saved and archived in the proprietary format on the computer or on the server.

In some embodiments, each whiteboard can comprise of one or more layers. A layer is grid within a defined boundary. The boundary can be in the shape of a rectangle. The outer limit of this rectangle can fill in the screen size.

A user input on a layer can be tracked by setting one or more grid cells to the status filled. Along with each filled-in grid cell other information (e.g. metadata) can also be tagged. Meta-data can include information such as size, color, thickness and/or the like (or any combination thereof).

The layers can have different levels of opacity. Each layer could be visually divided into pages. The page start and end points can be defined at the time of layer creation. In one example, each page is comprised of multiple layers. Once the layer has been created, then only the number of pages can be controlled. A single whiteboard can run into one or more pages (e.g. one-hundred pages or more). Each layer can exist in various stages.

One stage can include write/edit mode. In the write mode, user input movements can be transported across the network of the participating users in the form of grid coordinates along with user data. Once the coordinates reach the server, they can be committed on the layer. Coordinates data can be transmitted and/or exchanged between collaborating users. Each layer can be in write/edit mode the moment it is created and/or opened during a meeting session. Each layer(s) can be compressed and saved in the proprietary format on exit of write mode. All layers in a view window can be compressed as a single file in read mode. Each whiteboard window can be made up of one or more layers. A single session could have multiple whiteboard windows. In one example, two or more whiteboards can be superimposed with simultaneous annotations on each of those whiteboard. Some embodiments can have multiple whiteboards simultaneous operation independent of each other (i.e. annotation on each whiteboard is separate and not superimposed on another whiteboard) while some other multiple whiteboards can be superimposed with simultaneous annotations on each of those whiteboard. The system architecture allows a whiteboard window to serve as, inter alia: a common whiteboard for all collaborating users in a meeting, sharing of a whiteboard between specific two or more users, a whiteboard that is personal to a user and/or a whiteboard superimposed on another whiteboard.

It is noted that all four types of whiteboard windows options and/or multiple combinations or configurations can exist in a single meeting, with a single login, and all of the whiteboard windows tagged together are saved for all collaborating users. Write control can be user defined and/or configurable. Within the write mode, functionalities that can be made available include, inter alia, copy all/part of a layer and/or paste the copy content from any one whiteboard window to another in the same meeting. It can be possible to toggle or switch back and forth between different whiteboard windows. The whiteboard architecture can allow multiple annotations. Once a meeting is created and its content saved, it is possible to write/annotate on previously saved content. All whiteboard functions, such as copy, cut, paste, write, highlight etc., can be implemented on a separate set of layers without compromising integrity of the previous layers or saved content. The whiteboard application can be available both in online and offline environment enabling subsequent annotations in online or offline modes. In offline mode, the layers can be saved on a local disk and/or in a cloud-based database(s).

Example Deployment—Classroom Setting

FIG. 2 shows a teacher in a classroom with four students, according to some embodiments. In some embodiments, the teacher and students in the classroom can be equipped with individual wireless enabled writable tablets 205, 201, 202, 203, 204 that serve as a writing surface or scratch sheet. A centralized server 206 in the classroom or on school network connects the teacher with the students after they login as shown by solid lines 209, 210, 211, 212, 213. The dotted lines 214, 215, 216, 217, 218, 219, 220, 221, 222, 223 represent the wireless connectivity between the teacher's writable tablet 205 and students' writable tablets 201, 202, 203, 204.

The teacher on his/her writable tablet 205 can have a dashboard view of all students present in the class as thumbnail images. The teacher can have the necessary control visible on his/her writable tablet to perform various functions. Moreover, the teacher can also access each student on his/her writable tablet 205 via a simple click of the thumbnail images.

The students can share a common screen with the teacher so that they are able to view the work their teacher is doing on his/her writable tablet 205. The wireless tablets 201 to 205 can be connected to an LCD projector 207 to enable viewing 224, 225 on a large screen 208. This can simulate the current classroom scenario where the teacher is writing on the whiteboard with a marker. The key difference is that the present invention can allow the teacher to move around freely in the classroom, speak and write, and interact with the students.

In some embodiments, in addition to sharing the common screen with their teacher, the students can also open and write on an independent personal screen. This replicates the classroom situation where a teacher writes on the whiteboard (common screen) and the students take notes in their personal scratch book (personal screen). However, the key difference is that in the solution environment of some embodiments, the teacher can view the personal screen of any student on his/her writable tablet 205. For example, all that the teacher may need to do is simply click on the thumbnail impression of that student on his/her writable tablet 205. Once on the student's personal screen, the teacher can also have the option to write on it.

In some embodiments, the teacher can have the option to write on a different layer or screen superimposed on the student's personal screen. The teacher can also have the option to remove this new layer or screen that he/she has created on the student's personal screen. Further, in some embodiments, while viewing the student's personal screen, the teacher can write on a different layer substantially simultaneously (e.g. assuming networking and processing latencies and the like) even as the student continue to write on his/her personal screen. The key difference in this solution environment is that the student does not have to complete his/her work before the teacher can have the opportunity to correct or provide individualized instruction. The two processes can take place substantially simultaneously in real time. This can enable the teacher to not only be discreet, but also move from one student to another very quickly, and provide individualized help. Further, a teacher can project the work of a student on the larger screen 208 for others to view.

In some embodiments, in addition to sharing the common screen with their teacher, a student can also open and write on an independent personal screen that is overlaying or superimposed on the common screen. This can be invoked by using a Class Notes tab available on a student's tablet 201, 202, 203, 204. The student can see a mirror of the common screen with live contents synchronously streamed on his/her writable tablet 201, 202, 203, 204. While the teacher continues to write on the common screen, the present invention allows the student to annotate on the independent personal screen substantially simultaneously. This allows the student to make his/her own notes on his/her independent personal screen on top of the mirrored live content on the common screen on which a teacher is writing, substantially simultaneously, and in real-time. This replicates the classroom situation where a teacher writes on the whiteboard (common screen) and the students take notes in their personal scratch book (personal screen). However, the key difference is that in the solution environment of some embodiments, the student does not have to first copy a teacher's notes, and then reference those notes with his/her own notes. In some embodiments, there can be as many independent screens overlaying as the number of students in a classroom. Each student's independent personal screen overlaid or superimposed on top of the teacher's common screen can be viewed and saved only by that student at the end of the meeting.

In some embodiments, a student has the freedom to go back to previous pages of the common screen content and asynchronously annotate his/her notes anywhere without having to be on the same page of the live content.

In some embodiments, a teacher can create multiple study groups by clicking on the thumbnail impressions of students on the dashboard, and instruct each group to work on a specific problem set assigned to them. The students in a particular study group can share a common screen specific only to that group, and can have the option to open and work on their personal screen. The teacher can have the control to view each study group, provide help, and project 224, 225 their work on the larger screen 208 through the LCD projector 207.

In some embodiments, the students working on a common screen add or create separate layers superimposed on top of the common screen, and can choose to write on the common screen or on the new layers substantially simultaneously. Further, in some other embodiments, the teacher can view the common screen of a group, and annotate on the common screen or on another layer superimposed on top of the common screen while the students continue to work on the common screen. The key difference is that the teachers can work on the common screen and the new layers substantially simultaneously.

The middle-tier application can control a number of functions such as allowing a teacher to open and assign problem sets stored in a central repository/library, saving the student work, offline corrections, allow students to access and view their class work and corrected assignments anytime, anywhere. It can be possible to use some embodiments as a standalone solution or launch other applications available on the school network.

Example Deployment—Distance Learning and Remote Education

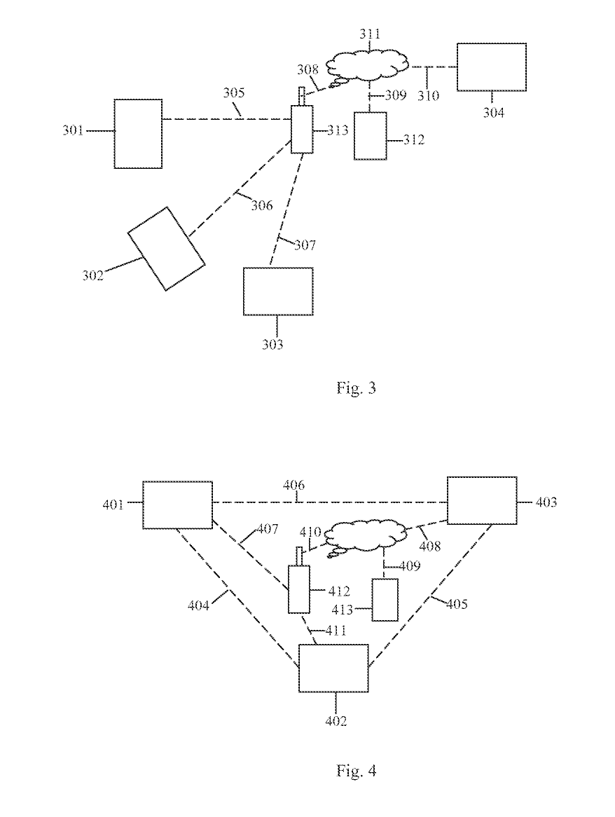

FIG. 3 shows three students and a teacher, all in remote locations, in a meeting, according to some embodiments. Some embodiments can allow the students an option to use a writable tablet 301, 302, 303 or a digitizing pad connected to their existing desktop PC or laptop computer through a USB port if they cannot afford a writable tablet 301, 302, 303. The students can use a stylus to write on a writable tablet 301, 302, 303 or a digitizing pad connected to their computer. The stylus movement can be captured on the computer screen. The student's work can be networked over the internet 305, 306, 307, 308, 309, 310, 311 to a teacher who is also equipped with a writable tablet 30.4 or digitizing pad connected to his/her computer. The internet service provider 313 can be different for each user. Both the student and the teacher are able to share and exchange identical written images on their computer screens, much the same way as in a web-conferencing session. In some examples, one key difference may be that there is little or no need for them to use a mouse or the keyboard. The solution can work by the student and the teacher writing on their respective writable tablets 301, 302, 303, and 304 or digitizing pads.

Further, the students and teacher, simultaneous to exchanging and sharing written images on their writable tablets 301, 302, 303, 304 or computer screens (assuming latencies), can use multiple modes of communication such as voice information using VoIP (voice over IP), instant messaging or chat, and video-conferencing. These applications and many other business functions as part of some embodiments can be hosted on a server 312 connected over the internet 309.

Although the teacher and students in remote locations can have the option to use the digitizing pads, the writable tablet 301 to 304 may eliminate the need for hand-eye coordination that may be required if a digitizing pad and computer screen are used.

Using the example embodiments, the teacher can work one-on-one or with multiple students by utilizing the available time while individual students are working on their specific problems. The teacher can also have the option to create homogeneous study groups to allow collaborative learning opportunities.

Some embodiments can be powered by feature-rich middle-tier software, designed to track student evaluation by monitoring and assessing their progress, assess teacher's performance, perform business functions and commercial transactions, and archive teaching sessions on the server 312.

Deployment—Collaboration among Dispersed Workforce

Some embodiments also allow a group of users or dispersed workforce in remote locations in an organization to connect with each other and share and exchange ideas and information in the same manner as described in the above section on Deployment—Distance Learning and Remote Education. FIG. 4 simulates meeting among three collaborating participants of a dispersed workforce, according to some embodiments. All collaborating participants equipped with writable tablets 401, 402, 403 or desktop PC or laptop computer are connected with each other 404, 405, 406 and to the server 413 over the internet 407, 408, 409, 410, 411. The interact service provider 412 can be different for each user.

The collaborating participants can open and work with multiple whiteboard windows, and all key functions, and processes described in section Deployment—Distance Learning and Remote Education also apply in this environment.

The initiator of the meeting can have the necessary control, and authorization to allow other collaborating participants to perform various functions such as write, erase, highlight, copy, cut and paste etc. In addition to using a whiteboard application, the initiating user can also share his computer screen and any application opened on the initiator's computer screen with the collaborating participant.

The initiator and the collaborating participant can switch between the application already open on the initiator's screen and the whiteboard application. Further, the collaborating participant can have the option to copy and paste a screen shot of an application, web page, and image onto the whiteboard pages. The collaborating participant can write on top of the copied material, and the written expressions superimposed on the copied material are saved at the end of the meeting.

Example Multiple Whiteboards in Operation—Classroom and Remote Education Environment

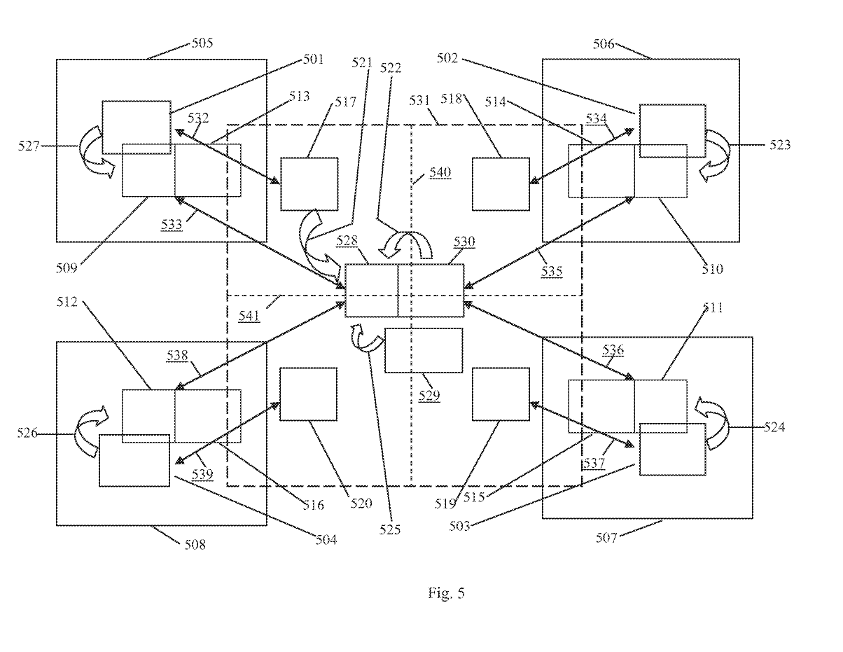

FIG. 5 depicts, in block diagram format, a teacher (e.g. a teacher's computing device) connected with four students (e.g. student computing devices) in a classroom or in remote locations, according to some embodiments. The description and reference numbers are summarized below.

Classroom or Distance Learning/Remote Education

| Description | Reference Numbers |
|---|---|
| Common Whiteboard screen on teacher's writable | 528 |
| tablet | |
| Common Whiteboard screen on students' writable | 509, 510, 511, 512 |
| tablets | |
| Teacher's personal whiteboard screen on | 529 |
| teacher's writable tablet | |
| Teacher's Assignment Whiteboard screen on | 530 |
| teacher's writable tablet | |
| Teacher's Assignment Whiteboard screen on | 513, 514, 515, 516 |
| students' writable tablets | |
| Student's Assignment Whiteboard screen on | 501, 502, 503, 504 |
| students' writable tablets | |
| Student's Assignment Whiteboard screen on | 517, 518, 519, 520 |
| teacher's writable tablet | |
| Students' writable tablets | 505, 506, 507, 508 |
| Teacher's writable tablet | 531 |
| Cut and Paste | 521, 522, 523, 524, |
| | 525, 526, 527 |
| Connectivity between Whiteboard Windows open | 532, 533, 534, 535, |
| on students' writable tablets and teacher's writ- | 536, 537, 538, 539 |
| able tablet that are connected through a wireless | |
| network | |
| Lines creating four quadrants with each quadrant | 540, 541 |
| defining interaction between a teacher and indi- | |
| vidual student screens | |

The teacher and students each have a writable tablet 531, 505, 506, 507, 508. In a classroom, all writable tablets 531, 505, 506, 507, 508 can be connected using a wireless network and to a central server on school network or in a remote location. In a remote education environment, the connectivity between the students and the teacher can be provided using the internet.

The teacher can be the initiator of a meeting and opens a common whiteboard screen 528 on his/her writable tablet 531. The teachers and students share the common whiteboard screens 528, 509, 510, 511, 512 on their respective writable tablets 531, 505, 506, 507, 508.

Teacher can be in control of the common whiteboard screens 528, 509, 510, 511, 512 and provide control to the students to write on their common whiteboard screens 509, 510, 511, 512. The number of students can vary (e.g. from forty in a small classroom to five-hundred in a large lecture or conference hall setting).

In addition, the teacher has a teacher assignment whiteboard screen 530 that can be shared with all students. This can enable the teacher to open an assignment from his personal folder and let students work on it after he has taught a concept or lesson. The control can reside with the teacher to allow annotation by one or all students on their teacher assignment whiteboard screen 513, 514, 515, 516.

The teacher may want to copy a page/screen from teacher assignment whiteboard screen 530 and cut and paste on the common whiteboard screens 528. This may be required if the teacher does not want to annotate on his/her teacher assignment whiteboard screen 530 but may like to work on a problem from his assignment and explain to the students.

In addition, each student can have a separate student assignment whiteboard screen 501, 502, 503, 504. This can enable students to open their assignments that the teacher has pushed in their individual folders. The teacher can have the capability to work on the Student assignment whiteboard screen 501, 502, 503, 504. The view of the student assignment whiteboard screen 517, 518, 519, 520 can be available to the teacher on his/her writable tablet 531 where he/she can write. In some embodiments, the teacher can add a new whiteboard layer superimposed on top of Student assignment whiteboard screen 501, 502, 503, 504 and annotate on the new whiteboard layer substantially simultaneously to the annotation by the students on their individual Student assignment whiteboard screen 501, 502, 503, 504. The teacher or the students can choose to delete or save the superimposed layer at the end of the meeting. This allows a teacher to individualize instruction to meet specific needs of a student isolated from other students.

The student can have the if teacher permits (assume student with writable tablet 505 has been granted permission), to cut and paste 527 a page/screen from his student assignment whiteboard screen 501 on to common whiteboard screens 509. This can enable the teacher to share good work of a student with others. This function can be required for remote education scenario with multiple students. Alternately, the teacher can also cut and paste 521 a page/screen from a student's assignment whiteboard screen 517 (assuming that the teacher wants to share the work of student with writable tablet 505) on the common whiteboard screen 528. The cut and paste 527 by the student described above can be utilized in any case for the study groups. The teacher can also have the capability to write on his teacher personal whiteboard screen 529 and cut and paste 525 a single page to the common whiteboard screen 528.

It is noted that in some embodiments, two modes of operation and annotations during the session can be implemented as described infra.

Synchronous Example

All the users are on the same page on a whiteboard screen and can be chosen by the teacher e.g. common whiteboard screen 528), and the teacher can have the control. No annotation by the students is allowed. This can be utilized, for example, when the teacher is specifically working on common whiteboard screen 528, and wants all students to be engaged.

Asynchronous Example

Students may be able to navigate back and forth independent of each other but no annotation is allowed. For example, this may be the case if the teacher opens an assignment out of his digital folder and allows students to browse before asking them to work on specific problems, or if a student desires to refer to the teacher's work on the common whiteboard screen 528, 501, 502, 503, 504 and would like to go to previous pages.

Example of Web-conferencing and Multiple Whiteboards in Operation—Collaboration among Dispersed Workforce Environment

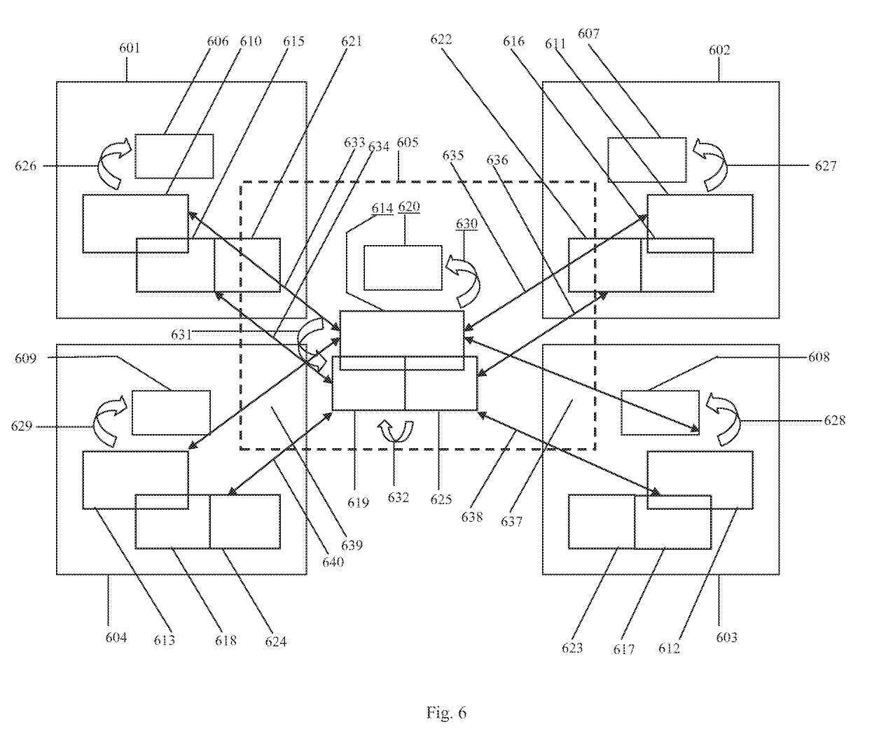

FIG. 6 shows the initiator of a meeting connected with four collaborating participants of a dispersed workforce in remote locations, according to some embodiments. The description and reference numbers are summarized below.

Collaboration among Dispersed Workforce

| Description | Reference Numbers |
|---|---|
| Common Whiteboard screen on Initiators writable | 619 |
| tablet | |
| Common Whiteboard screen on Collaborating | 615, 616, 617, 618 |
| Participants' writable tablets | |
| Initiator's personal whiteboard screen on | 620 |
| Initiator's writable tablet | |
| Collaborating Participants' personal whiteboard | 606, 607, 608, 609 |
| screen on Collaborating Participants' writable | |
| tablets | |
| Initiator's presentation whiteboard screen on | 625 |
| Initiator's writable tablet | |
| Initiator's presentation whiteboard screen on | 621, 622, 623, 624 |
| Collaborating Participants' writable tablets | |
| Application share screen on Initiator's writable | 614 |
| tablet | |
| Application share screen on Collaborating | 610, 611, 612, 613 |
| Participant's writable tablets | |
| Collaborating Participants' writable tablets | 601, 602, 603, 604 |
| Initiator's writable tablet | 605 |
| Connectivity between Whiteboard and application | 633, 634, 635, 636, |
| share Windows open on Collaborating Participant's | 637, 638, 639, 640 |
| writable tablets and Initiator's writable tablet | |
| Screen Capture | 626, 627, 628, 629, |
| | 630, 631 |
| Cut and Paste | 632 |

The initiator and collaborating participants can each have a writable tablet 605, 601, 602, 603, 604 or desktop PC or laptop computer that are connected with each other via VPN (virtual private network) and/or the Internet,

The initiator can initiate a web-conference meeting with the collaborating participants typically to share an application. The initiator and the collaborating participants can view application share screen 614, 610, 611, 612, 613 on their respective writable tablets 605, 601, 602, 603, 604. The initiator can have the option to allow a specific collaborating participant to take control of initiator's application share screen 614.

In addition, in some embodiments, the initiator and collaborating participants can share a common whiteboard screen 619, 615, 616, 617, 618. The initiator can have the control and ability to switch between application share screen 614 and common whiteboard screen 619. Both the initiator and collaborating participants can be enabled to annotate on the common whiteboard screen 619, 615, 616, 617, 618.

In addition to common whiteboard screen 619, the initiator can have a presentation whiteboard screen 625. This can enable initiator to open a file or presentation from his personal folder or the corporate library to share with the collaborating participants. Both the initiator and/or collaborating participants can annotate on the file opened on the presentation whiteboard screen 625, 621, 622, 623, 624. However, initiator can also have the option to cut and paste 631 a page/screen from the presentation whiteboard screen 625 on to common whiteboard screen 619. This may be the case if the initiator does not want to encourage annotation by the collaborating participants on the presentation whiteboard screen 621, 622, 623, 624 but discussion on a specific page of the file may be necessary.

The initiator and collaborating participants can have the screen capture 630, 631, 626, 627, 628, 629 and annotation capability. The collaborating participants can capture a screen 626, 627, 628, 629 from their application share screen 610, 611, 612, 613 and cut and paste on their personal whiteboard screen 606, 607, 608, 609 to take personal notes. The initiator can have more flexibility. He/she can capture the screen 630, 631 and cut and paste on his/her personal whiteboard screen 620 or on the common whiteboard screen 619. For example, this functionality may be utilized to initiate a discussion on a specific screen and annotate while sharing the application. Initiator can close one file and open another file on the presentation whiteboard screen 625.

In some embodiments, various modes of operation and annotations during the meeting can be implemented. For example, the modes can be synchronous and/or asynchronous.

Synchronous:

In the synchronous mode, everybody can be on the same page, and the initiator has the control. No annotation by the collaborating participants may be allowed.

Asynchronous:

In the asynchronous mode, the collaborating participants can navigate back and forth independent of each other but no annotation is allowed. This can be utilized generally in the beginning when the initiator may open a file for the collaborating participants to browse before getting into details. The collaborating participants can navigate and annotate while the meeting is in progress. In addition to annotation, various participating parties can communicate using a text box on the whiteboard screens 615, 616, 617, 618, 619, 606, 607, 608, 609, 620, 621, 622, 623, 624, 625 that is included in some embodiments but not shown in FIG. 6 for the sake of simplicity.

Various types of files can be saved including, such as files with annotations. These can be the files opened on presentation whiteboard screen 621, 622, 623, 624, 625 on the server or Personal whiteboard screen 606, 607, 608, 609, 620 that are resident on collaborating participants writable tablets 601, 602, 603, 604, 605 or desktop/laptop computers. Discussions on the common whiteboard screen 615, 616, 617, 618, and 619. Some embodiments can allow an annotation engine downloadable for the collaborating participants to work independent of a meeting by opening a file on the server or resident on their writable tablet 601, 602, 603, 604, 605 or desktop/laptop computers

Stylus Contact Time as Analytics

In some embodiments, a teacher may want to gauge the length of time a particular student spends on an assignment. The number of times a stylus contacts a layer or some surface area can be captured by the sensor and converted into a numeric value. The value can be incorporated into other analytics and be rationalized.

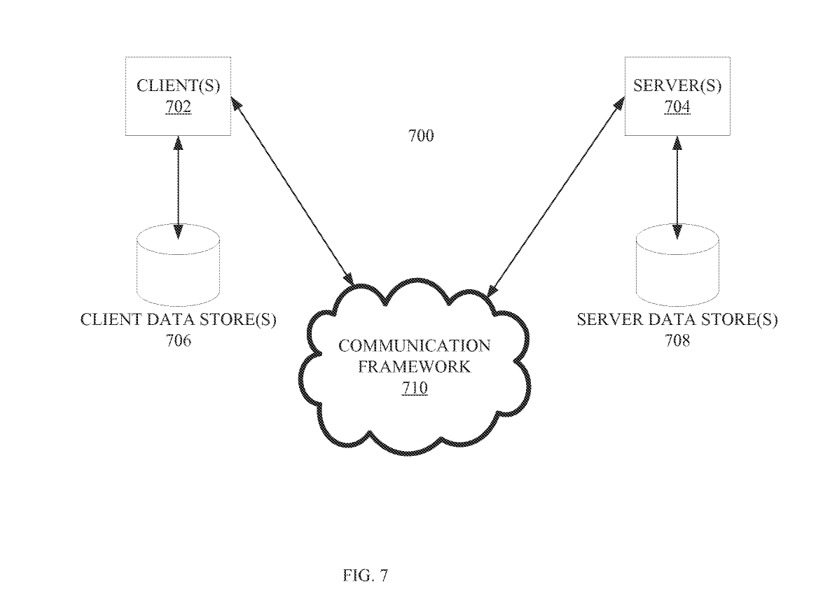

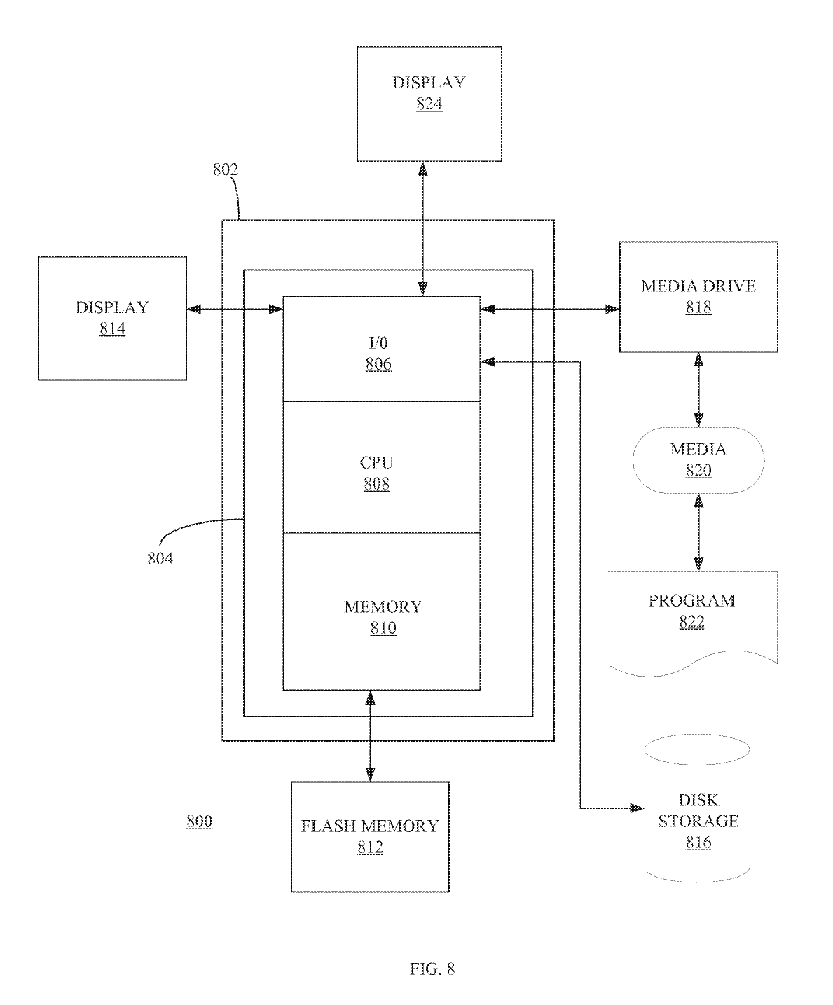

FIG. 7 and FIG. 8 provide exemplary computing environments, devices and architectures for the implementation of the various embodiments discussed herein.

FIG. 7 illustrates a sample computing environment 700 that can be utilized in some embodiments. The system 700 further illustrates a system that includes one or more client(s) 702. The client(s) 702 can be hardware and/or software (e.g., threads, processes, computing devices). The system 700 also includes one or more server(s) 704 (e.g. the web server discussed supra). The server(s) 704 can also be hardware and/or software (e.g., threads, processes, computing devices). One possible communication between a client 702 and a server 704 may be in the form of a data packet adapted to be transmitted between two or more computer processes. The system 700 includes a communication framework 710 that can be utilized to facilitate communications between the client(s) 702 and the server(s) 704. The client(s) 702 are connected to one or more client data store(s) 706 that can be employed to store information local to the client(s) 702. Similarly, the server(s) 704 are connected to one or more server data store(s) 708 that can be employed to store information local to the server(s) 704.

FIG. 8 depicts an exemplary computing system 800 that can be configure to perform any one of the above-described processes. In this context, computing system 800 may include, for example, a processor, memory, storage, and I/O devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to early out some aspects of the processes either in software, hardware, or some combination thereof.

FIG. 8 depicts computing system 800 with a number of components that may be used to perform the above-described processes. The main system 802 includes a motherboard 80.4 having an I/O section 806, one or more central processing units (CPU) 808, and a memory section 810, which may have a flash memory card 812 related to it. The I/O section 806 is connected to a display 824, a keyboard 814, a disk storage unit 816, and a media drive unit 818. The media drive unit 818 can read/write a computer-readable medium 820, which can contain programs 822 and/or data. Although, not shown, in some embodiments, computing system 800 can include an eye-tracking system and/or be coupled with an eye-tracking system.

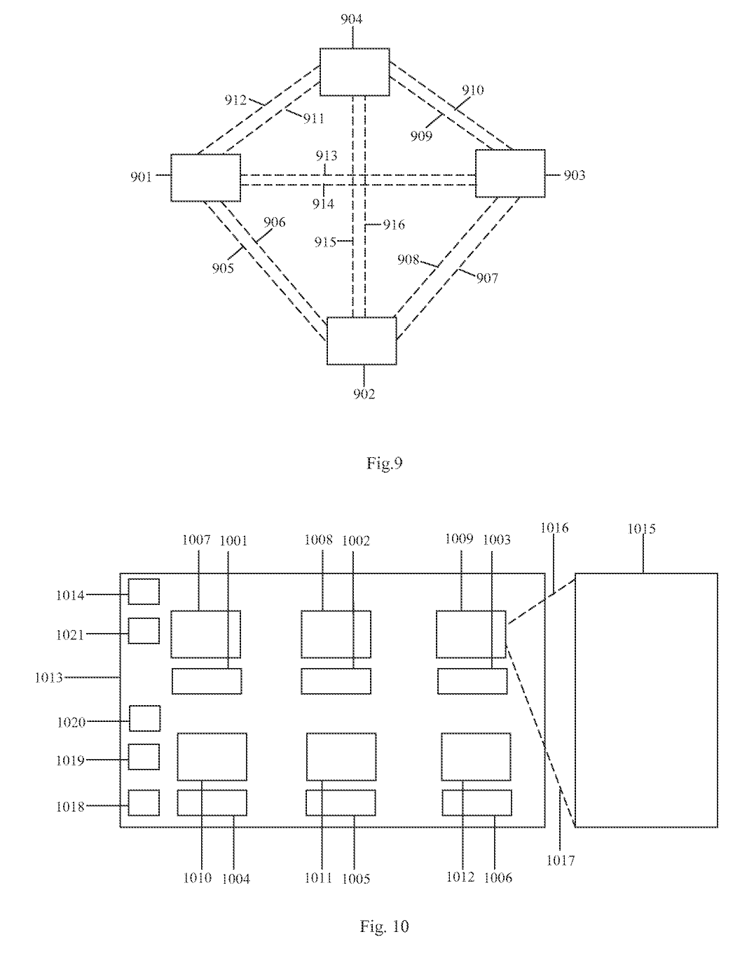

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e,g., Pascal, C, C++, Java) or some specialized application-specific language. Computing system 800 can be configured to perform the various steps and/or processes provided in the above descriptions of FIG. 1-6, FIG. 9 and FIG. 10.

Integration of Multiple Meetings and Communication Workflows

FIG. 9 shows a teacher 901 engaged in a collaboration meeting with three students 902, 903, 904 in remote locations, according to some embodiments. The teacher 901 and students 902, 903, 904 are connected and sharing voice information using voice over the IP (VoIP) showing dotted lines 905, 906, 907, 908, 909, 910, 911, 912, 913, 914, 915, 916.

The odd numbered lines 905, 911, 913 show one-way communication between the teacher 901 and a student 902, 904, 903. In some embodiments, using one-way communication 905, 911, 913, the teacher 901 can listen to a talking student 902, 903, 904 but the student 902, 903, 904 cannot listen to the teacher's 901 voice. The even numbered line 906, 912, 914 allow a student 902, 904, 903 to listen to the teacher's 901 voice.

Similarly, the odd numbered line 907 allows one-way communication between students 902, 903, the odd numbered line 909 allows one-way communication between students 903, 904, and the odd numbered line 915 allows one-way communication between students 902, 904. In some embodiments, the initiating student 902, 903, 904 can listen to a talking student 902, 903, 904 but not the other way round. In some embodiments, the even numbered line 908 in conjunction with odd numbered line 907 allows a two-way voice communication (e.g. listening and talking to each other) between students 902, 903. Similarly, in some embodiments, the even numbered line 910 in conjunction with odd numbered line 909 allows a two-way voice communication (e.g. listening and talking to each other) between students 903, 904. Further, in some embodiments, the even numbered line 916 in conjunction with odd numbered line 915 allows a two-way voice communication (e.g. listening and talking to each other) between students 902, 904.

Some embodiments can be configured to enable the initiating user, for example a teacher 901, to start multiple meetings, switch between meetings, and in the process control/manage voice communication with students 902, 903, 904 in those meetings. All of these meetings, in some embodiments, can be one-way or two-way.

Further, in some embodiments, the initiating user, for example a teacher 901, can either talk to all students 902, 903, 904 in the same meeting and/or choose to speak with a specific student 902, 903, or 904. In such a case, the other students 902, 903, or 904 attending the meeting may not be enabled to listen and/or participate in the communication process.

In some embodiments the initiating user, for example a teacher 901, can also have the flexibility of combining two separate meetings so that students 902, 903, 904 of different meetings are now in the same conference room. In such a scenario, the initiating user, for example a teacher 901, can choose the whiteboard window of any of the concurrent meetings, and share with all students 902, 903, 904. The initiating user, for example a teacher 901, can also switch from the whiteboard window of one meeting to another.

Dashboard

FIG. 10 illustrates a dashboard view of six students available to the teacher on his/her writable tablet 1013, according to some embodiments. The thumbnail view 1001, 1002, 1003, 1004, 1005, and 1006 of each student by name or picture is seen by the teacher on his/her writable tablet 1013. Further, a teacher has dashboard view of all six students' individual whiteboards 1007, 1008, 1009, 1010,1011, 1012 on his/her writable tablet 1013.

In some embodiment, a teacher may login to his/her individual account and initiate a class session by hitting the Start a Class button 1014. A student's scribbles or inputs from a stylus can be seen live on individual whiteboards 1007, 1008, 1009, 1010, 1011, 1012. The teacher may simply tab a specific individual whiteboard 1009 to bring up a full scale portrait view 1015 of a live individual whiteboard of that student. The dotted lines 1016, 1017 represent projections of individual whiteboard 1009 on to the full scale portrait view 1015.

In some embodiments, while viewing an individual whiteboard 1015 in full scale portrait view 1015, a teacher can choose to intervene and provide immediate one-on-one help to the student by tabbing on the Collaborate button 1018. The student will be prompted to either accept or decline the incoming collaboration request from the teacher. Once accepted, the teacher is able to annotate on a layer asynchronously along with the student's annotation.

In some embodiments, the teacher using thumbnail view 1001, 1002, 1003, 1004, 1005,1006 on his/her writable tablet 1013, can select and push custom content into a specific student's individual whiteboard 1007 that is viewed only by that student. Files in standard document forms (a doe file, a pdf file, a viz file, and the like) can be invoked from cloud based content bank and be shared with the selected student. Student can complete a customized assignment in class and enjoy individualized attention.

In some embodiments, the teacher can have the option to scale down the full scale portrait view 1015 of a student's individual whiteboard 1009 by tabbing the minimize button 1019. This option is viable during a one-on-one collaboration, and will minimize the full scale view of individual whiteboard 1015 back to thumbnail size individual whiteboard 1009 in the dashboard view. The teacher can choose to end the one-on-one collaboration session with the student by tabbing the End Session Button 1020. A message alert will appear to the student that the one-on-one session has ended. The teacher can continue to monitor other students in a similar manner.

In some embodiments, a teacher using the dashboard view can create custom group collaboration whiteboards separate from common whiteboards or students' individual whiteboards 1007, 1008, 1009, 1010, 1011, and 1012. This can be activated when the teacher tabs and holds the thumbnail view 1007 of one student and drags it over to the thumbnail view 1008 of a second student to create a new whiteboard. The two thumbnails 1007, 1008 will collapse, and the teacher can give a new name for the group whiteboard of those two students Once the name is entered, the original thumbnails 1007, 1008 of the two students go back to their placement on the dashboard view. Anew thumbnail representation 1021 of the group whiteboard is now present on the dashboard view.

In some embodiments, as an instructor-only function, the teacher can continue to assign additional students into existing thumbnail representation 1021 group whiteboard by dragging and dropping additional students using their thumbnail views 1009, 1010, 1011, or 1012 on his/her writable 1013. The students who have been assigned to the thumbnail representation 1021 group whiteboard can now see this group whiteboard thumbnail representation 1021 appear on their dashboard. They can enter the group whiteboard by tabbing on the thumbnail representation 1021 that they see on their writable tablets. Once the student enters the group whiteboard, scribbled group chat option is available to all the students. Each student can annotate on the group whiteboard or can create a different layer superimposed on the group whiteboard.

In some embodiments, the teacher can live broadcast a specific group whiteboard session by redirecting all students' views on a common whiteboard. Except for those students in the specific group whose whiteboard is being broadcasted, all other students at this point have the view only right to the selected group whiteboard.

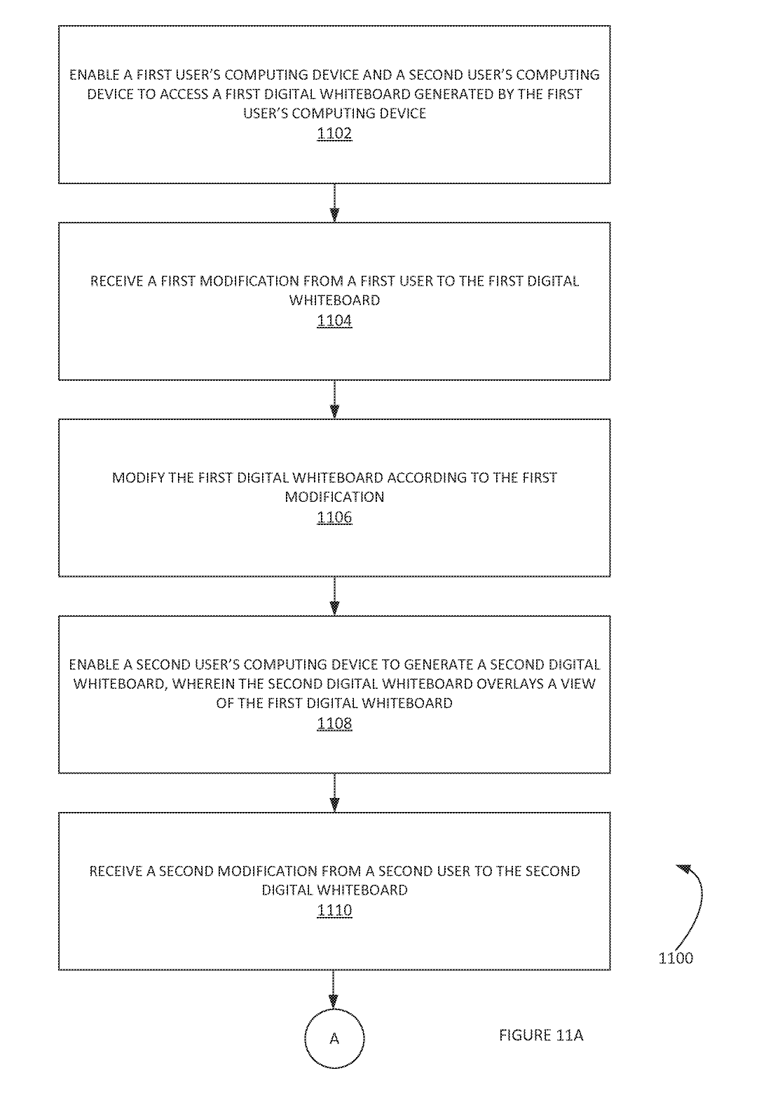

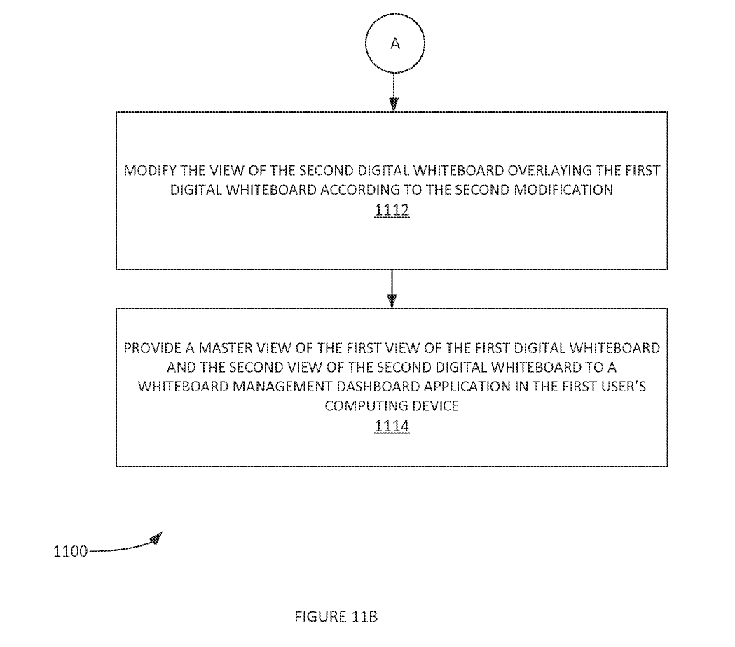

FIGS. 11A-B depict an example process 1100 for a real-time learning and collaboration solution system, according to some embodiments. In step 1102 of process 1100, a first user's computing device and a second user's computing device are enabled to access a first digital whiteboard generated by the first user's computing device. Example computing devices can be personal computers, tablet computers, laptop computers, smart phones and the like. The computing devices can include a real-time learning and collaboration application configured to implement process 1100 vis-à-vis the computing device. A digital whiteboard can be a set of multiple sequentially-generated whiteboard layers modifiable by the user with permission to modify. A whiteboard layer can include a user-modifiable view of a virtual whiteboard. Permissions and access to various digital whiteboards can be managed by an administrating user (e,g. a teacher, a supervisor, a training conductor, etc.). The computing device of the administrating user can include a management dashboard application. For example, the first whiteboard can be modifiable by the first user (a teacher) and not the second user a student). It is noted that in some examples, more users in addition to the second user can have computing devices that generate digital whiteboards. These digital whiteboards can overlay a display of the first digital whiteboard and thus be used to annotate the first digital whiteboards content. The administrator can have a master view of all extant digital whiteboards created by any user in the system. The administrator can group various user digital whiteboards into one or more overlay views. Additionally, the administrator can implement any of the example use cases provided supra.

In step 1104, a first modification is received from a first user to the first digital whiteboard. The first modification can be received by a digital whiteboard management process implemented in a cloud-computing environment and/or on a standalone server. The modification can include a digital writing content provided by the first user, a digital video content selected by the first user, a digital audio content selected by the first user and/or any other content examples provided herein. In step 1106, the first digital whiteboard is modified according to the first modification. In step 1108, a second user's computing device is enabled to generate a second digital whiteboard, wherein the second digital whiteboard overlays a view of the first digital whiteboard. In step 1110, a second modification is received from a second user to the second digital whiteboard. In step 1112, the view of the second digital whiteboard overlaying the first digital whiteboard is modified according to the second modification. In step 1114, a master view of the first view of the first digital whiteboard and the second view of the second digital whiteboard to a whiteboard management dashboard application in the first user's computing device. It is noted that the second user can scroll through the sequentially-generated whiteboard layers of the first digital whiteboard. The second user can also asynchronously annotate any whiteboard layer of the first digital whiteboard (e.g. by annotating a second digital whiteboard that overlays the first digital whiteboard). The asynchronous annotation can include the generation of another whiteboard overlaying an associated whiteboard layer of the first digital whiteboard. For example, a teacher could have created ten pages of a first digital whiteboard. The teacher could currently be writing on the tenth page. A student in the group can review all ten pages of the first digital whiteboard with a digital whiteboard application in the student's tablet computer. The student can annotate the second page (while the teacher is writing on the tenth page) by creating a second digital whiteboard that is overlaid over the second page of the first digital whiteboard.

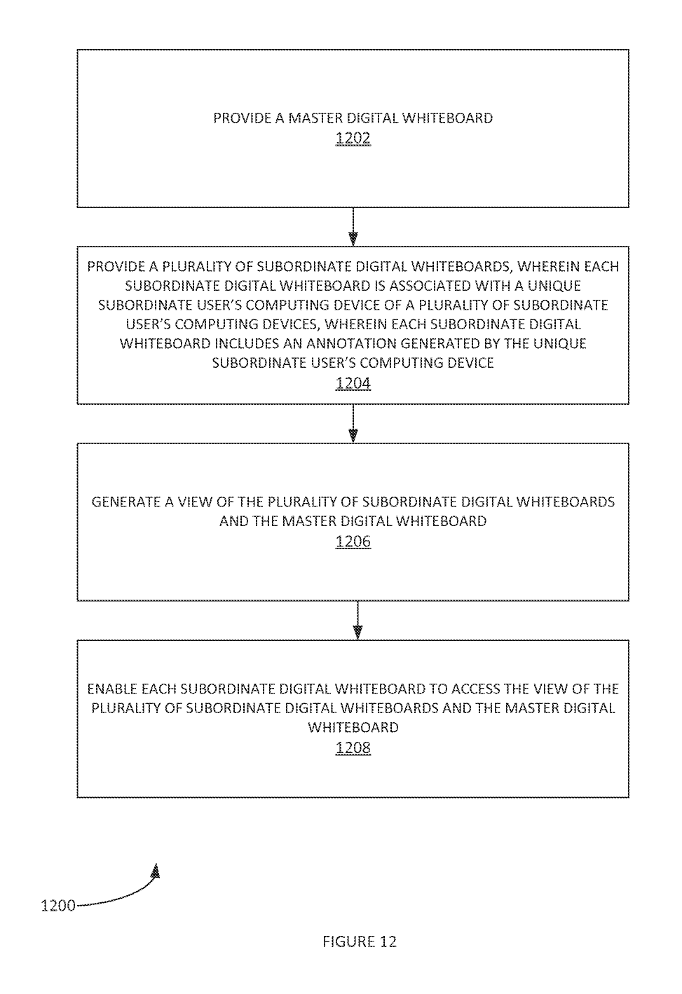

FIG. 12 depicts another process 1200 that can be utilized to implement various examples described herein, according to some embodiments. In step 1202, a master digital whiteboard is provided. The master digital whiteboard can be managed and implemented by a process in a server, cloud-computing environment and/or an application in an administrators computing device, according to various embodiments. In step 1204, a plurality of subordinate digital whiteboards are also provided. Each subordinate digital whiteboard can be associated with a unique subordinate user's computing device of a plurality of subordinate user's computing devices. Each subordinate digital whiteboard can includes an annotation generated by the unique subordinate user's computing device. In step 1206, a view of the plurality of subordinate digital whiteboards and the master digital whiteboard is generated. In step 1208, each subordinate digital whiteboard can access the view of the plurality of subordinate digital whiteboards and the master digital whiteboard. In some examples, a user of a subordinate digital whiteboard can access and annotate another subordinate digital whiteboard (e.g. by clicking on a tab associated with the other subordinate digital whiteboard).

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of a real-time learning and collaboration environment comprising:
enabling a first user's computing device and a second user's computing device to access a first digital whiteboard generated by the first user's computing device;
receiving a first modification from a first user to the first digital whiteboard;
modifying the first digital whiteboard according to the first modification;
enabling a second user's computing device to generate a second digital whiteboard, wherein the second digital whiteboard overlays a view of the first digital whiteboard;
receiving a second modification from a second user to the second digital whiteboard;
modifying the view of the second digital whiteboard overlaying the first digital whiteboard according to the second modification; and
providing a master view of the first view of the first digital whiteboard and the second view of the second digital whiteboard to a whiteboard management dashboard application in the first user's computing device.

2. The method of claim 1, wherein the first digital whiteboard comprises multiple sequentially-generated whiteboard layers modifiable by the first user, wherein a whiteboard layer comprises a user-modifiable view of a virtual whiteboard and wherein the first digital whiteboard is modifiable by the first user and not the second user.

3. The method of claim 1, wherein the first user is a teacher.

4. The method of claim 3, wherein the second user is a pupil.

5. The method of claim 1 further comprising:
enabling the second user to scroll through the sequentially-generated whiteboard layers of the first digital whiteboard; and
enabling the second user to asynchronously annotate any whiteboard layer of the first whiteboard, wherein an asynchronous annotation comprises generating another whiteboard overlaying an associated whiteboard layer of the first digital whiteboard.

6. The method of claim 1, wherein the second user's computing device comprises a tablet computer.

7. The method of claim 1 further comprising:
storing the first digital whiteboard layer in a database in a cloud-computing environment.

8. The method of claim 1, wherein the first modification comprises a digital writing content provided by the first user, a digital video content selected by the first user or a digital audio content selected by the first user.

9. The method of claim 8, wherein substantially simultaneously while the first user is writing on the first digital whiteboard layer, the second user generates an annotation substantially simultaneously on the second digital whiteboard layer.

10. The method of claim 9, wherein the annotation on the second digital whiteboard layer is superimposed on the first digital whiteboard layer from a display perspective.

11. The method of claim 1, wherein the first user's computing device and the second user's computing device are communicatively coupled with a computing network.

12. A method comprising:
providing a master digital whiteboard;
providing a plurality of subordinate digital whiteboards, wherein each subordinate digital whiteboard is associated with a unique subordinate user's computing device of a plurality of subordinate user's computing devices, wherein each subordinate digital whiteboard includes an annotation generated by the unique subordinate user's computing device;
generating a view of the plurality of subordinate digital whiteboards and the master digital whiteboard; and
enabling each subordinate digital whiteboard to access the view of the plurality of subordinate digital whiteboards and the master digital whiteboard.

13. The method of claim 12, wherein the master digital whiteboard comprises a computing platform independent interactive display.

14. The method of claim 12, wherein a subordinate digital whiteboard user can select and annotate another subordinate digital whiteboard.

15. The method of claim 12, wherein includes a virtual whiteboard and a content from a master digital whiteboard application in a master computing device.

16. The method of claim 15, wherein an administrator of the master digital whiteboard controls access and display of the plurality of subordinate digital whiteboards in the view of the plurality of subordinate digital whiteboards and the master digital whiteboard.

17. An information sharing and collaboration system comprising:
a master module configured to provide and manage a set of digital whiteboards comprising a master digital whiteboard and a plurality of subordinate digital whiteboards, wherein each subordinate digital whiteboard is associated with a unique subordinate user's computing device of a plurality of subordinate user's computing devices, wherein each subordinate digital whiteboard includes an annotation generated by the unique subordinate user's computing device;
a digital whiteboard client application module configured to provide a view of the plurality of subordinate digital whiteboards and the master digital whiteboard to a client digital whiteboard application operating in one or more user computing devices; and
a permissions module configured to enable each subordinate digital whiteboard to access the view of the plurality of subordinate digital whiteboards and the master digital whiteboard.

18. The method of claim 17, wherein the master digital whiteboard comprises a computing platform independent interactive display.

19. The method of claim 17, wherein a subordinate digital whiteboard user can select and annotate another subordinate digital whiteboard.

20. The method of claim 17, further comprising:
an administration module configured to provide a dashboard interface to an administrator's digital whiteboard application to control access and display of the plurality of subordinate digital whiteboards in the view of the plurality of subordinate digital whiteboards and the master digital whiteboard.
